(19) United States
(12) Patent Application Publication
(10) Pub. No.: US 2008/0306138 A1
(43) Pub. Date: Dec. 11, 2008

(54) STABLE NON-AQUEOUS POUR-ON COMPOSITIONS

(75) Inventors: Jacob Allen Zupan, Yardley, PA (US); Robert Bruce Albright, Chalfont, PA (US); Douglas Rugg, Lebanon, NJ (US); Izabela Galeska, Pennington, NJ (US); Chungjian Jerry Ong, Warren, NJ (US)

Correspondence Address: WYETH;PATENT LAW GROUP, 5 GIRALDA FARMS, MADISON, NJ, 07940, US

(73) Assignee: Wyeth, Madison, NJ (US)

(21) Appl. No.: 12/133,413

(22) Filed: Jun. 5, 2008

Related U.S. Application Data
(60) Provisional application No. 60/933,299, filed on Jun. 5, 2007.
(60) Provisional application No. 60/933,231, filed on Jun. 5, 2007.

(51) Int. Cl. A01N 43/02; A01N 37/52; A01P 7/02

(52) U.S. Cl. 514/450; 514/637

(57) ABSTRACT

The present invention relates to a stable, antiparasitic, non-aqueous pour-on parasiticidal composition which comprises an effective amount of amitraz, optionally a macrocyclic lactone, a stabilizer and a carrier system having no active hydroxyl group.

### CROSS-REFERENCE TO RELATED APPLICATIONS

This application claims the benefit under 35 U.S.C. §119(e) to U.S. provisional application No. 60/933,299, filed Jun. 5, 2007, and U.S. provisional application No. 60/933,231, filed Jun. 5, 2007, each of which is hereby incorporated by reference in its entirety.

### BACKGROUND OF THE INVENTION

In order to control external parasites on sheep, cattle and other animals including goats, pigs, horses and the like, it is a common practice to employ a localized topical application of a pour-on formulation containing one or more active ingredients. A pour-on formulation is typically liquid and is usually applied to the exterior of an animal as a line or a spot, which then acts to protect the external surface of the animal against external parasites such as lice, keds, mites, ticks, flies or the like. Ideally, when the pour-on formulation is applied topically to a localized area, the active ingredient migrates over the surface of the animal to protect its whole external surface area.

Active ingredients generally employed in pour-on compositions include ectoparaciticides such as ixodicides. Amitraz, a valuable veterinary product, is effective against strains of ticks resistant to other chemical classes of ixodicides. Amitraz also possesses sufficient persistence on hair and wool to control all stages of parasitic ticks. The unique expellant action of amitraz causes ticks to withdraw mouthparts rapidly from, and fall off, the host animal. Effective tick control in conjunction with effective ecto or endoparasiticidal control is highly desirable in the raising, breeding and housing of healthy agronomic and domestic animals. However, amitraz is, unfortunately, chemically unstable in the presence of carriers having a reactive hydroxyl group such as alcohols, glycols, water and the like. This characteristic has limited the development of veterinary compositions containing amitraz, and especially those containing amitraz and at least one additional parasiticidal agent, due to the combination of the instability of amitraz in carriers which contain a reactive hydroxyl group and the insolubility of many parasiticidal agents in carriers which do not contain a reactive hydroxyl group.

Moreover, macrocyclic lactones, particularly moxidectin is an exceptionally difficult compound to formulate. Factors such as the size of the molecule and lack of substituent sugar moieties render the molecule lipophilic and insoluble in many solvents used in conventional formulations. Accordingly, combination of two particularly difficult compounds in a single formulation is particularly difficult.

Furthermore, acceptable topical formulations must be sufficiently easy to apply, not wash off during rainfall, retain efficacy on wet animals, dry within a reasonable period of time without impairment of the animal's appearance, be gentle on the animal's coat, non-irritating to the animal's skin and maintain its effectiveness on the animal through normal activities of the animal, such as exposure to sun and water. Most desirably, the composition will provide the active ingredients in a formulation which will have at least a sufficient duration of activity, so as to avoid the necessity of frequent reapplications.

Therefore, it is an object of this invention to provide a pour-on, parasiticidal veterinary composition containing amitraz, and at least one additional parasiticidal compound, particularly moxidectin, which is stable, water-fast and which demonstrates a high degree of efficacy of each of the active ingredients.

It is another object of the invention to provide a method for the prevention, treatment and control of parasital infection or infestation in a homeothermic animal.

A feature of this invention is that the compositions provided offer improved efficacy over a broad spectrum of parasites for an extended period of time.

Other objects and features of the invention will become more apparent from the detailed description set forth hereinbelow.

### SUMMARY OF THE INVENTION

The present invention provides a stable antiparasitic non-aqueous pour-on composition which comprises an effective amount of each of amitraz and at least one additional parasiticidal compound and a carrier system having no active hydroxyl group. Preferably, the additional parasiticidal compound is a macrocyclic lactone, more particularly, moxidectin. In a more particular embodiment, the composition comprises a stabilizer.

Also provided is a method for the treatment and control of parasitic infection and infestation and a process for the preparation of a veterinary parasiticidal pour-on composition.

Other objects, features and advantages of the present invention will become apparent from the following detailed description. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### DETAILED DESCRIPTION OF THE INVENTION

Frequently, highly polar carriers containing active hydroxyl groups such as water, alcohol, glycol or the like are utilized to prepare pour-on compositions due to their compatibility with animal skin, hide and/or hair, and their ability to dissolve relatively high concentrations of an active ingredient. Topical veterinary compositions containing amitraz as one of the active ingredients are highly desirable due to the effective and persistent activity of amitraz against a wide variety of ticks, including ticks resistant to other parasiticidal actives. Heretofore, veterinary compositions containing amitraz and an additional parasiticidal compound have been limited by the instability of amitraz in the presence of carriers or excipients which contain an active hydroxyl group.

When amitraz is added to a known commercial pour-on macrocyclic lactone formulation such as that described in U.S. Pat. No. 6,514,951 for moxidectin, the resultant composition is unstable.

Surprisingly, it has now been found that amitraz and at least one additional parasiticidal compound, particularly moxidectin, may be formulated in a stable, non-irritating pour-on composition by employing a carrier system comprising a non-hydroxyl-containing solvent and a stabilizer. Preferably the composition is substantially free of water. In a particular embodiment, the solvent comprises caprylic/capric triglyceride, isopropyl myristate, mineral oil or a combination thereof. Accordingly, in a preferred embodiment, the present invention provides a topical veterinary parasiticidal composition which comprises a carrier system as outlined herein and an effective amount of each of amitraz and moxidectin.

Advantageously, the pour-on compositions of the present invention are well tolerated by the host animal, are not malodorous, are capable of spreading well and rapidly over the animal's body and are readily absorbed through the hide or skin of the treated animal. A further benefit is that the compositions retain efficacy on wet skin or hide and resist wash off.

In one embodiment, the composition is a veterinary parasiticidal composition. More particularly, the non-hydroxyl-containing solvent comprises an aromatic solvent. More particular still, the non-hydroxyl-containing solvent comprises C₇-C₁₂ arylalkanes. In another embodiment, the non-hydroxyl-containing solvent comprises mineral oil or caprylic/capric triglyceride or a combination thereof. In another embodiment, the non-hydroxyl-containing solvent comprises isopropyl myristate. In another embodiment, the non-hydroxyl-containing solvent comprises a mixture of aromatic hydrocarbons, caprylic/capric triglyceride and isopropyl myristate. In another embodiment of the invention, the composition comprises a non-hydroxyl-containing solvent, a stabilizer, moxidectin and amitraz, wherein the stabilizer is bis-2,6-diisopropylphenylcarbodiimide.

One aspect of the invention provides a composition comprising a non-hydroxyl-containing solvent, a stabilizer, and amitraz; wherein
either (a) the composition comprises a macrocyclic lactone; or (b) said non-hydroxyl-containing solvent comprises:
   about 5% to about 20% w/v of an aromatic solvent;
   about 10% to about 75% w/v of caprylic/capric triglyceride or mineral oil or a combination thereof; and
   0% to about 15% w/v isopropyl myristate; and
      provided that the composition is substantially free of hydroxyl-containing solvents.

In another embodiment, the composition comprises (a), the macrocyclic lactone. More particular still, the macrocyclic lactone is moxidectin; alternatively, the macrocyclic lactone is ivermectin.

In another embodiment, the composition comprises (b), wherein the non-hydroxyl-containing solvent comprises:

about 5% to about 20% w/v of an aromatic solvent;

about 10% to about 75% w/v of caprylic/capric triglyceride or mineral oil or a combination thereof; and

about 1% to about 15% w/v isopropyl myristate.

An additional aspect of the invention provides a composition comprising a non-hydroxyl-containing solvent, a stabilizer, moxidectin and amitraz.

In another embodiment, the composition comprises ivermectin.

Another aspect of the invention provides a veterinary parasiticidal composition comprising:
(a) about 1% to about 5% w/v of amitraz;
(b) about 0% to about 3% w/v of moxidectin;
(c) about 0% to about 15% w/v of a stabilizer;
(d) about 5% to about 20% w/v of an aromatic solvent;
(e) about 10% to about 75% w/v of caprylic/capric triglyceride or mineral oil or a combination thereof; and
(f) about 0% to about 15% w/v isopropyl myristate.

More particularly, the composition comprises about 0.01% to about 2% w/v of moxidectin. More particular still, moxidectin is present at about 0.1% to about 1% w/v. Another embodiment further comprises ivermectin. In another embodiment, the aromatic solvent consists essentially of C₇-C₁₂ arylalkanes (e.g. toluene, xylenes, cumene, and/or pseudocumene). In another embodiment, amitraz is present at about 1% to about 3% w/v. In another embodiment, aromatic solvent is present at about 12% to about 18% w/v. In another embodiment, the caprylic/capric triglyceride or mineral oil or combination thereof is present at about 25% to about 65% w/v. In another embodiment, caprylic/capric triglyceride is present at about 25% to about 65% w/v. In another embodiment, the isopropyl myristate is present at about 5% to about 10% w/v. In another embodiment, the stabilizer is bis-2,6-diisopropylphenylcarbodiimide. More particularly, bis-2,6-diisopropylphenylcarbodiimide is present at about 1% to about 5% w/v. Another embodiment further comprises a viscosity modifier. More particularly, the viscosity modifier is a polybutene polymer. Another embodiment further comprises about 5-15% cetyl octonate.

Another embodiment comprises an excipient selected from the group consisting of dyes, antimicrobial agents, and antioxidants or a mixture thereof. More particularly, the composition comprises the antioxidant Tenox 22.

Another aspect of the invention provides a veterinary parasiticidal composition comprising:
(a) about 1% to about 5% w/v of amitraz;
(b) about 0.1% to about 15% w/v of a stabilizer;
(c) about 5% to about 20% w/v of an aromatic solvent;
(d) about 10% to about 75% w/v of caprylic/capric triglyceride or mineral oil or a combination thereof; and
(e) about 2% to about 15% w/v isopropyl myristate.

More particularly, the composition comprises about 0.01% to about 2% w/v of moxidectin. More particular still, moxidectin is present at about 0.1% to about 1% w/v. In another embodiment, the composition further comprises ivermectin. In another embodiment, the aromatic solvent consists essentially of C₇-C₁₂ arylalkanes (e.g. Aromatic 100®). In another embodiment, the aromatic solvent (e.g. petroleum) is present at about 12% to about 18% w/v. In another embodiment, the amitraz is present at about 1% to about 3% w/v. In another embodiment, the caprylic/capric triglyceride or mineral oil or combination thereof is present at about 25% to about 65% w/v. More particularly, the caprylic/capric triglyceride is present at about 25% to about 65% w/v. In another embodiment, isopropyl myristate is present at about 5% to about 10% w/v.

In another embodiment, the stabilizer is bis-2,6-diisopropylphenylcarbodiimide. More particularly, the bis-2,6-diisopropylphenylcarbodiimide is present at about 1% to about 5% w/v.

In another embodiment, the composition of the invention further comprises a viscosity modifier. More particularly, the viscosity modifier is a polybutene polymer. In another embodiment, the viscosity modifier is Indopol H1900.

In another embodiment, the composition of the invention further comprises an excipient selected from the group consisting of dyes, antimicrobial agents, and antioxidants or a mixture thereof.

In another embodiment, the composition comprises less than 1% w/v water, or less than 0.5% w/v water, or less than 0.25% w/v water.

In another embodiment, the stabilizer in the composition is a miscible stabilizer.

Another aspect of the invention provides a method for the treatment and control of a parasiticidal infection or infestation in a homeothermic animal which comprises topically administering to said animal a composition which comprises a non-hydroxyl-containing solvent, a stabilizer, moxidectin and amitraz.

Alternatively, an aspect of the invention provides a method for the treatment or control of a parasiticidal infection or infestation in a homeothermic animal which comprises topically administering to said animal a non-hydroxyl-containing solvent, a stabilizer, and amitraz; wherein
either (a) the method further comprises administering a macrocyclic lactone; or (b) said non-hydroxyl-containing solvent comprises:
   about 5% to about 20% w/v of an aromatic solvent;
   about 10% to about 75% w/v of caprylic/capric triglyceride or mineral oil or a combination thereof; and
0% to about 15% w/v isopropyl myristate.

More particularly, the method does not comprise administering a hydroxyl-containing solvent on the animal.

In another embodiment, said composition is administered as a pour-on. In another embodiment, said animal is selected from the group consisting of swine; cattle; horses; and sheep. In another embodiment, said ectoparasiticidal infection or infestation is caused by ticks, lice, keds, mites or flies. In another embodiment, said ectoparasiticidal infection or infestation is caused by ticks.

Another aspect of the invention provides a composition which comprises a topically-administered non-hydroxyl-containing solvent, a stabilizer, moxidectin and amitraz for the treatment and control of a parasiticidal infection or infestation in a homeothermic animal.

A further aspect of the invention provides a composition which comprises a topically-administered non-hydroxyl-containing solvent, a stabilizer, moxidectin and amitraz in the manufacture of a medicament for the treatment and control of a parasiticidal infection or infestation in a homeothermic animal.

The effective amounts of amitraz may be about 1.0-5.0% w/v, optionally with at least one additional parasiticidal compound to about 1.0-10.0% w/v of the total composition. For example, amitraz may be present at about 0.5-3.0% w/v, preferably 1.0-2.5% w/v, and the additional parasiticidal compounds may be present at about 0.01-2.0% w/v, preferably 0.1-1.0% w/v, more preferably 0.5% w/v. The effective amounts of the additional parasiticidal compounds may vary according to the potency of the compounds, the method of application, the host animal, the target parasite, the degree of infestation, or the like.

As applied to any embodiments of the invention, representative parasiticidal compounds suitable for use in the composition of the invention include: macrocyclic lactones such as moxidectin, milbemycin oxime, abamectin, doramectin, ivermectin, selamectin or eprinomectin; chitin synthesis inhibitors including benzoylphenylureas such as diflubenzuron, flufenoxuron, teflubenzuron, novaluron, fluazuron, or the like; juvenile hormone mimics such as methoprene, hydroprene, pyriproxyfen, fenoxycarb, or the like; pyrethroid insecticides such as permathrin, cypermethrin, α-cypermethrin or the like; phenylpyrazole insecticides such as fipronil; organophosphate insecticides such as chlorfenvinphos, diazinon, malathion, terbufos, or the like; oxime carbamate insecticides; semicarbazones such as endoxcarb or metaflumizone; imidacloprid; or the like; preferably macrocyclic lactones, more preferably moxidectin or ivermectin. Moxidectin is especially preferred for use with amitraz, due to its complementary mode of parasiticidal activity, and its chemical compatibility with, and solubility in, carriers which do not contain an active hydroxyl group.

As used herein, a “non-hydroxyl-containing solvent” indicates a solution of one or more substances, all of which do not contain free-hydroxyl groups. Hydroxyl-containing solvents include water, alcohols, glycols, cromadol PMP, etc. Examples of preferred non-hydroxyl-containing solvents include aromatic solvents (e.g. xylenes, cumenes, toluene), isopropyl myristate, carprylic/capric triglyceride, gamma-hexylactone, N,N-diethyl-m-toluamide, 1-methoxy-2-propyl acetate, DMSO,

The term “carrier” is used throughout the specification and claims to include carrier blends, that is mixtures of more than one substance.

As used herein, the term “w/v” designates weight/volume, and the term “mg/kg” designates milligrams per kilogram of body weight.

As used herein, the term “stabilizer” or “stabilizing agent” refers to a substance that prevents or reduces degradation, reactivity or interaction of other ingredients in the composition of the invention. Preferably, the stabilizer is a “soluble stabilizer” indicating that it is dissolved in the composition. Preferably, the stabilizer of the present invention prevents or reduces degradation of amitraz, such as by acting as water scavenger. One example of a stabilizing agent of the present invention is an antihydrolysis agent, such as 2,6-diisopropylphenylcarbodiimide (Stabaxolo).

As used in the specification and claims, the terms “about” and “approximately” designate that a value is within a statistically meaningful range. Such a range can be typically within 20%, more typically still within 10%, and even more typically within 5% of a given value or range. The allowable variation encompassed by the terms “about” and “approximately” depends on the particular system under study, and can be readily appreciated by one of ordinary skill in the art.

As used herein, the term “substantially free” means that the material being discussed is present in the composition, if at all, as an incidental impurity in less than about 1%. Preferably, the compositions of the present invention are “substantially free” of hydroxylated solvents (e.g. water or cromadol) which are present in less than 1% w/v, more preferably, less than 0.5% w/v.

The caprylic/capric triglyceride or mineral oil or a combination thereof may be present in the inventive composition in amounts of about 10-75.0% w/v, preferably 25-65% w/v. The isopropyl myristate may be present in amounts of about 2-15% w/v, preferably about 5-10% w/v, more preferably about 10% w/v.

In addition to a carrier system having no active hydroxyl groups, amitraz and a second parasiticidal agent, the pour-on compositions of the invention may also include one or more additional ingredients. Examples of suitable additional ingredients are: stabilizers such as carbodiimides, antioxidants; spreading agents; preservatives; adhesion promoters; active solubilisers; viscosity modifiers such as polybutene polymers; UV blockers or absorbers; colourants; surface active agents, including anionic, cationic, non-ionic and ampholytic surface active agents; and those excipients conventionally employed in veterinary topical compositions. For example stabilizers, such as carbodiimides, i.e. di-(2,6-di-isopropylphenyl)carbodiimide, dicyclohexylcarbodiimide, or the like, or a mixture thereof, may be present in the composition of the invention in amounts of about 0-15% w/v, preferably 0-10% w/v, more preferably about 1-5% w/v. Viscosity modifiers such as polybutene polymers may be present in the inventive composition in amounts of about 0-20% w/v, preferably about 5-15% w/v, more preferably about 10% w/v.

In one embodiment, the composition of the invention may further comprise aromatic solvents, such as C₇-C₁₂ arylalkane solvent mixtures such as Aromatic 150®, Aromatic 100® (manufactured by Exxon-Mobil), or the like, or a mixture thereof. Aromatic solvents may be present in the composition of the invention in amounts of about 5.0-20% w/v, preferably about 12-18% w/v, more preferably about 15% w/v.

Excipients such as dyes, antimicrobial agents, antioxidants or mixtures thereof may be included in the composition of the invention. The amounts of said excipients suitable for use in the invention range from about 0 or 0.0005% to 2.0% w/v. Additional agents to be added to the compositions include, UV-absorbing compounds, photostabilizers, viscosity modifying agents, thickeners, taste enhancers or deterrents, vitamins, adherents, perfumes, deodorants, physiologically or dermatologically acceptable carriers, diluents, excipients or adjuvants.

Advantageously, the stable pour-on parasiticidal veterinary composition of the invention allows for high stability and commensurately high potency of the active ingredients and demonstrates no irritation to the skin/hide/hair of the host animal. Accordingly, the present invention provides a method for the treatment and control of parasiticidal infection or infestation in a homeothermic animal, which comprises topically administering to said animal a composition which comprises a carrier system comprising caprylic/capric triglyceride, isopropyl myristate, mineral oil, or a combination thereof; and an effective amount of each of amitraz and at least one additional parasiticidal compound.

Homeothermic animals suitable for treatment using the composition and method of the present invention include: swine, cattle, sheep, horses, goats, camels, water buffalos, donkeys, fallow deer, reindeer, dogs, cats or the like, preferably swine, cattle, horses or sheep, more preferably cattle or sheep.

Ectoparasitic infection or infestations suitable for treatment by the method of the invention include lice, keds, mites, ticks, flies or the like.

In actual practice, the composition of the invention may be administered in dose rates of mg of active ingredient per kg of body weight of the host animal. Dose rates suitable for use in the method of invention will vary depending upon the mode of administration, the species and health of the host animal, the target parasite, the degree of infection or infestation, the breeding habitat, the potency of the additional parasiticidal compound, and the like. In general, a dose of about 0.5-3.0 mg/kg of amitraz is suitable and, in the case wherein the additional parasiticidal compound is a macrocyclic lactone such as moxidectin or ivermectin, a dose of about 0.01-1.0 mg/kg of a macrocyclic lactone, preferably 2.5 mg/kg of amitraz and 0.5 mg/kg of macrocyclic lactone. Such doses may be particularly applicable to large animals such as swine, cattle, horses or sheep.

The present invention also provides a process for the preparation of a veterinary pour-on parasiticidal composition which comprises: admixing a portion of the caprylic/capric triglyceride or mineral oil or a combination thereof with isopropyl myristate, amitraz and a second parasiticidal agent to form a first solution; and treating said first solution with the remaining caprylic/capric triglyceride or mineral oil or a combination thereof optionally containing dissolved polybutene polymer to form a second homogeneous solution, optionally passing said homogeneous solution through a solid dehydrating agent.

Parasiticidal compounds suitable for use in the process of the invention include: macrocyclic lactones such as abamectin, doramectin, ivermectin, selamectin, eprinomectin, moxidectin or milbemycin oxime; chitin synthesis inhibitors including benzoylphenylureas such as diflubenzuron, flufenoxuron, teflubenzuron, novaluron, fluazuron, or the like; juvenile hormone mimics such as methoprene, hydroprene, pyriproxyfen, fenoxycarb, or the like; pyrethroid insecticides such as permathrin, cypermethrin, α-cypermethrin or the like; phenylpyrazole insecticides such as fipronil; organophosphate insecticides such as chlorfenvinphos, diazinon, malathion, terbufos, or the like; oxime carbamate insecticides; imidacloprid; semicarbazones such as endoxcarb or metaflumizone; and the like, preferably macrocyclic lactones, more preferably moxidectin or ivermectin.

Solid dehydrating agents suitable for use in the process of the invention include any conventional solid reagents useful for absorbing and removing trace amounts of water from a solution, for example silica gel, magnesium sulfate, sodium sulfate, charcoal, molecular sieves, or the like, preferably molecular sieves, more preferably 4 Å molecular sieves.

For a more clear understanding of the invention, the following examples are set forth hereinbelow. These examples are merely illustrative and are not understood to limit the scope or underlying principles of the invention in any way. Indeed, various modifications of the invention, in addition to those shown and described herein, will become apparent to those skilled in the art from the examples set forth hereinbelow and the foregoing description. Such modifications are also intended to fall within the scope of the appended claims.

Unless otherwise noted all parts are parts by weight. In the following examples the ingredients described below are used.

| | Trade name, | |
|---|---|---|
| Function | Manufacturer | Generic |
| solvent | Aromatic 100 ®, Exxon-Mobil | aromatic |
| | | hydrocarbons* |
| antioxidant | Tenox 22 ®**, Eastman | proprietary |
| | Chemical Co. | |
| viscosity modifier | Indopol H1900 ®, | polybutene polymer |
| | INEOS Oligomers | |
| stabilizer | Stabaxol I ®, | bis-2,6-diisopropyl- |
| | RheinChemie Group | phenylcarbodiimide |
| carrier | Miglyol 812, | caprylic/capric |
| | SASOL Chemie | triglyceride |

*Composition of Aromatic 100 ®: C9-C10 aromatics:

| | |
|---|---|
| Name | Concentration |
| SOLVENT NAPHTHA (PETROLEUM), | ~100% |
| LIGHT AROMATIC: | |
| CUMENE | <4% |
| PSEUDOCUMENE | <35.0% |
| (1,2,4-TRIMETHYLBENZENE) | |
| XYLENES | 2-4% |

**Composition of Tenox 22 ®: (approximately) 20% tertiary-butyl-4-
hydroxy-anisole (BHA), 6% tertiary butylhydroquinone (TBHQ), 4%
citric acid and carrier solvent (vegetable oil, propylene glycol, glycerides
and/or ethanol (QS).

### EXAMPLE 1

### Preparation of Parasiticidal Pour-on Compositions

| Component | A | B | C | D |
|---|---|---|---|---|
| Description | % w/v | % w/v | % w/v | % w/v |
| amitraz | 2.5 | 2.5 | 2.5 | 2.5 |
| moxidectin | 0.5 | 0.5 | — | — |
| ivermectin | — | — | 0.5 | 0.5 |
| Aromatic | 15 | 15 | 15 | 15 |
| 100 | | | | |
| IPM* | 10 | 10 | 10 | 10 |
| Indopol | 10 | 10 | 10 | 10 |
| H1900 | | | | |
| Stabaxol I | — | 5.0 | — | — |
| Miglyol 812 | qs** | qs** | qs** | — |
| Mineral Oil | — | | | qs** |

*Isopropyl Myristate
**quantity sufficient to obtain a total of 100% w/v

### Method of Preparation

A mixture of Aromatic 100, isopropyl myristate and a portion of the miglyol or mineral oil, under nitrogen is treated sequentially with moxidectin or ivermectin and amitraz; stirring is continued until solution is complete. In a separate vessel, Indopol H1900 is dissolved in the remaining portion of the miglyol or mineral oil at 50°-60° C. and cooled to room temperature. The first solution containing amitraz is treated with the Indopol H11900 solution and stirred until homogeneous. The resultant homogeneous solution is passed through a bed of activated 4 Å molecular sieves.

### EXAMPLE 2

### Preparation of Parasiticidal Pour-on Compositions

Using essentially the same procedure described in Example 1 hereinabove, the compositions shown below were prepared.

| Component | A | B | C | D | E | F |
|---|---|---|---|---|---|---|
| Description | % w/v | % w/v | % w/v | % w/v | % w/v | % w/v |
| amitraz | 2.5 | 2.5 | 2.5 | 2.5 | 2.5 | 2.5 |
| moxidectin | 0.5 | 0.5 | 0.5 | 0.5 | 0.5 | 0.5 |
| Aromatic 100 | 15 | 15 | 15 | 15 | 15 | 15 |
| IPM* | 10 | 10 | — | 10 | 10 | 10 |
| Indopol H1900 | 10 | 10 | 10 | 10 | 10 | 10 |
| Cetyl | — | — | 10 | — | — | — |
| Octanoate | | | | | | |
| Stabaxol I | — | — | — | 1.0 | 3.0 | — |
| Miglyol | — | qs** | qs** | qs** | qs** | qs*** |
| Mineral Oil | qs | — | — | — | — | — |

*Isopropyl Myristate
**Miglyol 812 in a quantity sufficient (qs) to obtain a total of 100% w/v
***Miglyol 840 in a quantity sufficient (qs) to obtain a total of 100% w/v

### EXAMPLE 3

### Preparation of Comparative Pour-on Compositions

The compositions shown below were prepared according to U.S. Pat. No. 6,514,951, except amitraz was added to the completed formulation and the resultant mixture was stirred until homogeneous.

| Component | A | B | C |
|---|---|---|---|
| Description | % w/v | % w/v | % w/v |
| amitraz | 2.5 | 2.5 | 2.5 |
| moxidectin | — | 0.5 | 0.5 |
| ivermectin | 0.5 | — | — |
| Aromatic 100 | 15 | 15 | 15 |
| Tenox 22 | 0.05 | — | 0.05 |
| Crodamol PMP* | 10 | 10 | 10 |
| Indopol H1900 | 10 | 10 | 10 |
| Miglyol 812 | qs** | qs** | qs** |

*PPG-2 myristyl ether propionate
**quantity sufficient to obtain a total of 100% w/v

### EXAMPLE 4

### Preparation of Ectoparasiticidal Pour-on Compositions

| Component | A | B | C | D |
|---|---|---|---|---|
| Description | % w/v | % w/v | % w/v | % w/v |
| amitraz | 3.0 | 2.5 | 3.0 | 3.0 |
| Aromatic 100 | 15 | 15 | 15 | 15 |
| Tenox 22 | — | — | 0.5 | — |
| IPM* | 10 | 10 | 10 | 10 |
| Indopol H1900 | 10 | 10 | 10 | 10 |
| Stabaxol I | — | 5.0 | 3.0 | 1.0 |
| Miglyol 812 | qs** | qs** | qs** | — |
| Mineral Oil | — | | | qs** |

*Isopropyl Myristate
**quantity sufficient to obtain a total of 100% w/v

### Method of Preparation

A mixture of Aromatic 100, isopropyl myristate and a portion of the miglyol or mineral oil, under nitrogen is treated amitraz; stirring is continued until solution is complete. In a separate vessel, Indopol H1900 is dissolved in the remaining portion of the miglyol or mineral oil at 50°-60° C. and cooled to room temperature. The first solution containing amitraz is treated with the Indopol H1900 solution and stirred until homogeneous. The resultant homogeneous solution is passed through a bed of activated 4 Å molecular sieves.

### EXAMPLE 5

### Preparation of Ectoparasiticidal Pour-on Compositions

Using essentially the same procedure described in Example 4 hereinabove, the compositions shown below were prepared.

| Component | A | B | C | D |
|---|---|---|---|---|
| Description | % w/v | % w/v | % w/v | % w/v |
| amitraz | 3.0 | 3.0 | 2.5 | 2.5 |
| Aromatic 100 | 15 | 15 | 15 | 15 |
| IPM* | 10 | 10 | 10 | 10 |
| Indopol H1900 | 10 | 10 | — | 10 |
| Cetyl Octanoate | | | 10 | |
| Stabaxol I | — | — | — | 1.0 |
| Miglyol 812 | — | qs** | qs** | qs** |
| Mineral Oil | qs** | — | — | — |

*Isopropyl Myristate
**quantity sufficient to obtain a total of 100% w/v

### EXAMPLE 6

### Preparation of Comparative Pour-on Compositions

The compositions shown below are prepared according to U.S. Pat. No. 6,514,951, except amitraz is added to the completed formulation and the resultant mixture is stirred until homogeneous.

| Component | A | B | C |
|---|---|---|---|
| Description | % w/v | % w/v | % w/v |
| amitraz | 2.5 | 3.0 | 3.0 |
| Aromatic 100 | 15 | 15 | 15 |
| Tenox 22 | 0.05 | — | 0.05 |
| Crodamol PMP* | 10 | 10 | 10 |
| Indopol H1900 | 10 | 10 | 10 |
| Miglyol 812 | qs** | qs** | qs** |

*PPG-2 myristyl ether propionate
**quantity sufficient to obtain a total of 100% w/v

### EXAMPLE 7

### Comparative Evaluation of the Stability of Test Pour-On Compositions

In this evaluation, test compositions prepared in Examples 2 and 3 were stored at 25° C. and 50° C. for 8 weeks. The samples were analyzed for % actives, as compared to time 0, at regular intervals. The results are shown in Table I below.

TABLE I
Comparison of Stability of Pour-On Compositions

| Storage | Invention Ex. 2B | | Comparative Ex. 3B | |
|---|---|---|---|---|
| 25° C. | % moxidectin | % amitraz | % moxidectin | % amitraz |
| 4 W | 100.6 | 100.9 | 99.0 | 97.4 |
| 8 W | 100.6 | 100.1 | 99.4 | 96.2 |
| 12 W | 100.4 | 100.7 | 97.6 | 93.2 |
| 2 W | 99.0 | 98.0 | 97.2 | 91.0 |
| 4 W | 98.4 | 95.3 | 94.1 | 83.5 |
| 8 W | 93.1 | 87.7 | 83.3 | 71.9 |

As can be seen from the data shown hereinabove in Table I, the composition of Example 2B (substantially free of a hydroxyl-containing solvent) is more storage stable than the composition of Example 3B (containing a hydroxyl-containing solvent (Crodamol PMP*)).

### EXAMPLE 8

### Comparative Evaluation of the Stability of Test Pour-On Compositions

In this evaluation, test compositions prepared in Examples 2 and 3 were stored at 25° C. and 60% relative humidity and at 40° C. and 20% relative humidity for 26 weeks. The samples were analyzed for % actives, as compared to time 0, at regular intervals. The results are shown in Table II below.

TABLE II
Comparison of Stability of Pour-On Compositions

| | Invention Ex. 2B | | Comparative Ex. 3C | |
|---|---|---|---|---|
| Storage | % moxidectin | % amitraz | % moxidectin | % amitraz |

25° C.
60% RH

| | | | | |
|---|---|---|---|---|
| 4 W | 99.2 | 99.1 | 99.3 | 92.2 |
| 8 W | 100.7 | 100.9 | 99.0 | 85.6 |
| 12 W | 100.9 | 100.5 | 98.9 | 81.1 |
| 26 W | 99.1 | 98.2 | 94.7 | 71.1 |
| 52 W | 99.7 | 98.1 | 85.8 | 63.4 |

40° C.
20% RH

| | | | | |
|---|---|---|---|---|
| 2 W | 100.5 | 100.0 | 99.1 | 88.7 |
| 4 W | 98.6 | 98.2 | 97.7 | 81.2 |
| 8 W | 99.9 | 98.7 | 93.7 | 71.2 |
| 13 W | 99.6 | 97.4 | 89.4 | 67.0 |
| 26 W | 95.1 | 92.5 | 74.0 | 61.5 |

As can be seen from the data shown hereinabove in Table II, the composition of Example 2B (substantially free of a hydroxyl-containing solvent) is more storage stable than the composition of Example 3C (containing a hydroxyl-containing solvent (Crodamol PMP*)).

TABLE III
Additional Stability of Pour-On Compositions

| | | | | Ex. 2D | | Ex. 2E | |
|---|---|---|---|---|---|---|---|
| | | Ex. 2B | | 1% Stabaxol ® | | 3% Stabaxol ® | |
| Storage T | Time | Amitraz | Moxidectin | Amitraz | Moxidectin | Amitraz | Moxidectin |
| 30° C./65% RH | 0 | 100.0 | 100.0 | 100.0 | 100.0 | 100.0 | 100.0 |
| | 1 | 100.1 | 99.9 | 100.9 | 100.3 | 100.9 | 100.5 |
| | 2 | 98.7 | 98.7 | 100.6 | 101.5 | 100.5 | 103.0 |
| | 3 | 98.8 | 99.1 | 99.3 | 99.4 | 100.7 | 100.9 |
| | 6 | 95.8 | 97.2 | 97.8 | 97.9 | 99.0 | 98.5 |
| | 9 | 94.4 | 98.0 | 98.7 | 98.1 | 100.2 | 99.3 |
| | 12 | 83.4 | 95.0 | 99.7 | 99.3 | 100.4 | 99.5 |
| 40° C./75% RH | 1 | 100.3 | 100.0 | 101.1 | 100.7 | 101.5 | 100.6 |
| | 2 | 98.4 | 98.8 | 99.6 | 100.8 | 100.6 | 103.0 |
| | 3 | 95.2 | 97.8 | 98.5 | 98.4 | 99.6 | 99.7 |
| | 6 | 63.2 | 88.5 | 97.8 | 97.8 | 99.0 | 98.8 |
| | 12 | 0.0 | 67.2 | 96.7 | 96.9 | 98.5 | 98.7 |

As can be seen from the data shown in Table III, compositions of the present invention comprising stabilizers and a non-hydroxyl-containing solvent are substantially more stable than comparative compositions.

### EXAMPLE 9

### Evaluation of the Efficacy of Test Compositions

A. In this evaluation, 8 animals were selected from a group of 51 cattle, which were infested with Ixodes Holocyclus (paralysis tick). Cattle in Group 1 received a placebo treatment and served as a negative control. On day 0, the treated group received a dose of example 6A at 1 mL of formulation per 10 kg. The formulation was applied topically from the base of the tail to the withers. Ticks were subsequently applied to the animals on days 7, 14, 21 and 28. Ticks were counted daily for 3 days post-treatment as well as for three days after reinfestation. Ticks were assessed according to viability (live healthy/sick/dead). Ticks were removed after 3 days to reduce the potential of tick paralysis. The group receiving formulation 6A had tick efficacy of 85.7% 72 hours after treatment. Complete efficacy (100%) was obtained against ticks attached on day 7 and day 14. Efficacy declined to 79% and 50% for ticks attached on days 21 and 28, respectively.
B. Formulation 2F was tested against Ixodes Holocyclus (paralysis tick) on young calves in Australia. 22 Dairy calves weighing between 43.5 and 71.5 kg and aged between 21 and 49 days were used in the study. Paralysis ticks were applied to the animals prior to the start of the trial. There were three treatment groups: Group A was an untreated control group. Group B was a competitive product positive control group Group C was treated with 0.5% Moxidectin/2.5% Amitraz at a rate of 1 mL per 10 Kg of bodyweight. On day 0, the treated group received a dose of the above-noted formulation at 1 mL of formulation per 10 kg. The formulation was applied topically from the base of the tail to the withers. Ticks were subsequently applied to the animals on days 7, 14, 21 and 28. Ticks were counted daily for 3 days post-treatment as well as for three days after reinfestation. Ticks were assessed according to viability (live healthy/sick/dead). Ticks were removed after 3 days to reduce the potential of tick paralysis. The group receiving the above-noted formulation had tick efficacy of 97.7% 72 hours after treatment. Complete efficacy (100%) was obtained against ticks attached on day 7, day 14 and day 17. Efficacy declined to zero by day 24.

What is claimed is:

1. A veterinary parasiticidal composition comprising a non-hydroxyl-containing solvent, a stabilizer, and amitraz; wherein
either (a) the composition comprises a macrocyclic lactone; or (b) said non-hydroxyl-containing solvent comprises:
about 5% to about 20% w/v of an aromatic solvent;
about 10% to about 75% w/v of caprylic/capric triglyceride or mineral oil or a combination thereof; and
0% to about 15% w/v isopropyl myristate; and
provided that the composition is substantially free of hydroxyl-containing solvents.

2. The composition of claim 1, comprising (a) the macrocyclic lactone, wherein the macrocyclic lactone is moxidectin.

3. The composition of claim 2, comprising about 0.1% to about 3% w/v of moxidectin.

4. The composition of claim 3, comprising about 0.1% to about 2% w/v of moxidectin.

5. The composition of claim 4, wherein moxidectin is present at about 0.1% to about 1% w/v.

6. The composition of claim 1, wherein the non-hydroxyl-containing solvent comprises at least one of an aromatic solvent, of caprylic/capric triglyceride mineral oil, isopropyl myristate, cetyl octonate or a viscosity modifier.

7. The composition of claim 1, comprising (a) the macrocyclic lactone, wherein the macrocyclic lactone is ivermectin.

8. The composition of claim 1, comprising about 0.1% to about 15% w/v of a stabilizer.

9. The composition of claim 1, wherein the stabilizer is a soluble stabilizer.

10. The composition of claim 1, wherein the stabilizer is bis-2,6-diisopropylphenylcarbodiimide.

11. The composition of claim 10, wherein bis-2,6-diisopropylphenylcarbodiimide is present at about 1% to about 5% w/v.

12. The composition of claim 1, comprising about 1% to about 5% w/v of amitraz.

13. The composition of claim 12, comprising about 1% to about 3% w/v of amitraz.

14. The composition of claim 1, wherein said non-hydroxyl-containing solvent comprises:
about 5% to about 20% w/v of an aromatic solvent;
about 10% to about 75% w/v of caprylic/capric triglyceride or mineral oil or a combination thereof; and
about 1% to about 15% w/v isopropyl myristate.

15. The composition of claim 14, comprising about 5% to about 15% isopropyl myristate.

16. The composition of claim 14, comprising about 10% isopropyl myristate.

17. The composition of claim 1, wherein the aromatic solvent consists essentially of C₇-C₁₂ arylalkanes.

18. The composition of claim 1, wherein the aromatic solvent is present at about 12% to about 18% w/v.

19. The composition of claim 1, wherein the caprylic/capric triglyceride or mineral oil or combination thereof is present at about 25% to about 65% w/v.

20. The composition of claim 19, wherein caprylic/capric triglyceride is present at about 25% to about 65% w/v.

21. The composition of claim 1, comprising less than 0.5% water.

22. The composition of claim 1, further comprising a viscosity modifier.

23. The composition of claim 22, wherein the viscosity modifier is a polybutene polymer.

24. The composition of claim 1, further comprising about 5-15% cetyl octonate.

25. The composition of claim 1, further comprising an excipient selected from the group consisting of dyes, antimicrobial agents, and antioxidants or a mixture thereof.

26. The composition of claim 1, comprising:
(a) about 1% to about 5% w/v of amitraz;
(b) about 0.1% to about 3% w/v of moxidectin;
(c) about 1% to about 15% w/v of a stabilizer;
(d) about 5% to about 20% w/v of an aromatic solvent;
(e) about 10% to about 75% w/v of caprylic/capric triglyceride or mineral oil or a combination thereof; and
(f) 0% to about 15% w/v isopropyl myristate.

27. A method for the treatment or control of a parasiticidal infection or infestation in a homeothermic animal which comprises topically administering to said animal a non-hydroxyl-containing solvent, a stabilizer, and amitraz; wherein
either (a) the method further comprises administering a macrocyclic lactone; or (b) said non-hydroxyl-containing solvent comprises:
about 5% to about 20% w/v of an aromatic solvent;
about 10% to about 75% w/v of caprylic/capric triglyceride or mineral oil or a combination thereof; and
0% to about 15% w/v isopropyl myristate.

28. The method of claim 27, wherein the step of topically administering comprises a pour-on solution administered to the animal.

29. The method of claim 27, wherein said animal is selected from the group consisting of swine; cattle; horses; and sheep.

30. The method of claim 27, wherein said parasiticidal infection or infestation is caused by ticks, lice, keds, mites or flies.

31. The method of claim 27, wherein said parasiticidal infection or infestation is caused by ticks.
